(19) United States
(12) Patent Application Publication
(10) Pub. No.: US 2010/0145808 A1
(43) Pub. Date: Jun. 10, 2010

(54) DOCUMENT IMAGING WITH TARGETED ADVERTISING BASED ON DOCUMENT CONTENT ANALYSIS

(75) Inventors: David M. Hilbert, Palo Alto, CA (US); Kandha Sankarapandian, Palo Alto, CA (US); Anthony Dunnigan, Berkeley, CA (US); John Adcock, Menlo Park, CA (US)

Correspondence Address: SUGHRUE MION, PLLC, 2100 PENNSYLVANIA AVENUE, N.W., SUITE 800, WASHINGTON, DC, 20037, US

(73) Assignee: FUJI XEROX CO., LTD., Tokyo (JP)

(21) Appl. No.: 12/329,856

(22) Filed: Dec. 8, 2008

(51) Int. Cl. G06Q 30/00; G06Q 20/00

(52) U.S. Cl. 705/14.66; 705/30; 705/37

(57) ABSTRACT

A method and system for delivery of targeted advertisement via multifunction document imaging devices. Imaging devices used for copying, scanning, faxing and printing documents are used to deliver advertisements, coupons, and other promotional material to users. The imaging device is capable of delivering targeted promotional material based on analysis of the documents content passing through the device. Targeting is based on device history, user history or user demographics. Device history and user history are compiled from the contents of the documents processed respectively at a device and by a user. Demographics are inferred from a demographics model using user identity or document content input to the model. Advertisements may be delivered via paper, the device display, and other means.

### FIELD OF THE INVENTION

This invention generally relates to targeted advertising methods and systems and more specifically to methods and systems for delivery of targeted advertising to users of multifunction devices (MFDs).

### BACKGROUND OF THE INVENTION

Various services enable advertisers to deliver targeted promotional material to users who are browsing the web. The promotional materials may be targeted based on the keywords submitted by the user to a search engine, the pages viewed by the user and other factors. Web searches on some web sites yield targeted advertisements based on the context of the search. Targeted advertisements on other websites may be based on the content and context of the website. When a printout of these websites is obtained, targeted advertisements that appear on the web or in PDF documents are also included on the printout.

In addition to allowing advertisers to deliver targeted promotional material, this model of advertising also provides benefits to the users, web publishers and ad-targeting service providers. Under this model, the users can freely access ad-supported web sites and services; the web publishers can generate revenue without charging users; and ad-targeting service providers reap substantial profits even after sharing revenue with publishers.

Point of sale (POS) systems at many establishments, place advertisements on the receipt provided to the customer. For example, coupons may be printed with a grocery store receipt. Each item is identified to the system as the purchase is being made and the coupons are typically related to the items purchased.

Self-service kiosks, such as a photo kiosk and greeting card kiosks, may also include systems and methods for placing advertisements on the printout provided to the customer.

Conventional imaging systems, such as copiers, printers, scanners, fax machines, of MFDs that include some or all of these functions, may include the capability of providing advertisements on a current document being imaged using the device. In most cases, the advertisement provided with these conventional systems is not correlated to the content of the material being copied or printed and is not targeted to the user. In one case, disclosed in Japanese Published Patent Application 2002-290706, a copier device finds keywords in the single document that is being copied and adds advertisements to the copy provided to the user based on the identified keywords. In this conventional case, while the advertisement is correlated to the keywords found in the single document that is being copied, the advertisement is not targeted to the user. The information used to target the advertisement is based solely on the presence of keywords in the single document being copied.

Of all the above systems and methods of providing advertisement to a user, only web sites are capable of delivering targeted advertisements as the user views the electronic documents on the web. There is no way for other advertisers to deliver similarly targeted advertisements to users of document imaging devices, when the users are copying, faxing, scanning or printing a document using the device. This is a wasted opportunity for advertisers, for companies that could provide such an ad-targeting service and for manufacturers of MFDs.

### SUMMARY OF THE INVENTION

Aspects of the present invention provide a system and a method for advertisers to deliver targeted advertisements to a user when the user uses a MFD or a document imaging device to copy, scan, fax or print documents. According to aspects of the present invention, the targeting of the advertisement is based on contents of the documents being processed by the device. According to further aspects of the present invention, the targeting is based on contents of a current document and demographics of the user.

Aspects of the present invention provide a document imaging device capable of delivering targeted promotional material based on content analysis of the document passing through the device.

In some aspects of the invention, advertisements are targeted based on device history, user history, and other factors. The device history is developed from contents of the documents having been processed at the particular device during a period of time. The user history is developed from the contents of the documents having been processed by the particular user at one or more imaging devices. The device history or the user history may be used directly for targeting advertisements. Alternatively, the user history may be used to produce a user profile or user demographics that is in turn used to achieve the targeting.

In some aspects of the invention, advertisements can also be targeted based on user demographics. The user demographics may be inferred from the contents of a current document or from a collection of documents processed by the user or the device aggregated over some period of time. In addition to or instead of the contents of the document being currently processed, other factors may be used for deducing user demographics. Alternatively, user demographics may be directly input to the device through a smart card carried by the user which may store user demographic information itself, or serve to identify the user in which case demographic information previously associated with the user may be retrieved from another source.

The system and method of the present invention create a new venue for marketers to reach customers and a new opportunity for generating advertising revenue. The system and method of the present invention also provide a recurring revenue opportunity for manufacturers of multifunction devices.

Aspects of the present invention are capable of delivering targeted advertisements in a variety of formats and using a variety of delivery means with support for multiple advertising accounting models. The formats include, for example, text advertisements, image advertisements, audio advertisements, video advertisements, and interactive advertisements. The delivery means include, for example, on printed paper, on the device display, on a large collocated display, on the user's printable card, on the user's portable storage/processing device, in a modified digital version of a scanned document, or via an electronic “job receipt” or email sent to the user. The advertising accounting models include, for example, cost-per-thousand-impressions (CPM) and cost-per-click (CPC).

In one exemplary aspect of the present invention, history and profile of the imaging device is used to find targeted advertisement. For example, the device collects and analyzes all the copy, scan, fax and print data to generate a “device profile” containing the most common keywords passing through the device, the most common genre of documents passing through the device, or another categorization of the documents having been processed by the device during a given period of time. The device submits this profile information to the online advertising service, which returns targeted advertisements to the device. The device periodically selects an advertisement from this pool and shows it on the device welcome screen, even when no one is actively using the device. The device also selects advertisements from this pool of device-targeted advertisements whenever it cannot successfully retrieve targeted advertisements for a given document or for a given user. The device cannot retrieve targeted advertisements when, for example, the document contains no meaningful information for ad retrieval, the document analysis is not effective on the document, the document analysis is not sufficiently fast for the document or the user's selected device job, or the advertising network has no targeted advertisements for the document. In each of these cases, the device would continue to deliver targeted advertising based on a profile of the device's job history.

In one exemplary aspect of the invention, history and profile of the user is used to target the advertising. Conditions prompting the use of the user profile may be similar to conditions prompting the use of device profile. The user profile may be based on the history of documents copied or otherwise imaged at the particular device use by the user. The user profile may be based on the history of the documents imaged by the user at a number of devices. The devices may be connected such that they can share use information; alternatively, user history may be recorded on a smart card carried by the user. The user profile may be based on user's demographics deduced from user history in addition to a variety of factors that include the location of the device and the time of the day.

In one exemplary aspect of the invention, user demographics inferred from contents of a current document are used to find targeted advertisement. For example, the user places a magazine article on the platen of a document imaging device and selects the “copy” function. The device captures an image of the article and applies optical character recognition (OCR) to extract keywords and images or detect a genre of the document. The device uses the extracted content for input to a demographic model which yields the demographics of the user based on the input content. The device then submits the demographics to an online advertising service which returns various targeted advertisements to the device. The device then selects a certain number of text advertisements and prints them in the margin of the physical copies of the magazine article. The device increments the “impression” count for each of the advertisements depending on the number of copies made, notifies the advertising service, and the advertising service periodically bills advertisers based on impression counts. The advertising revenue may be used to reduce the copying fee for customers.

Exemplary aspects of the present invention provide a method for delivering targeted advertisements to a user of a multifunction device. The method includes identifying the user, obtaining user history, the user history being a compilation of data determined from contents of documents processed by the user, targeting advertisements to the user responsive to the user history to obtain user targeted advertisement, and delivering the user targeted advertisement to the user.

Exemplary aspects of the present invention provide a method for delivering targeted advertisements to a multifunction device. The method includes obtaining a device history, the device history being a compilation of data determined from contents of documents processed by the multifunction device during a first period, targeting advertisements to the multifunction device responsive to the device history to obtain device targeted advertisement, and delivering the advertisement to the user at the multifunction device.

Exemplary aspects of the present invention provide a method for delivering targeted advertisements to a user of a multifunction device. The method includes receiving a current document from a user, analyzing content of the current document to obtain document analysis results, retrieving a demographic mapping model, determining user demographics for the user from input of the document analysis results to the demographic mapping model, targeting advertisements to the user responsive to the user demographics to obtain user targeted advertisement, and delivering the user targeted advertisement to the user.

Exemplary aspects of the present invention provide a multifunction device for providing targeted advertisements. The multifunction device includes an imaging screen for imaging documents received at the device, a communication module for receiving documents transmitted to the device from remote locations and for transmitting data to remote locations, a processor for receiving an image of the documents from the imaging screen and for analyzing the image to obtain document contents of the documents, a memory for storing the document contents, a display for displaying targeted advertisements to users of the device, and a printer for printing modified documents, the modified documents including the documents received at the device and the targeted advertisements provided at the device. The targeted advertisements include first targeted advertisements. The first targeted advertisements are targeted to each of the users according to user history. The user history is compiled from contents of the documents processed responsive to requests from the user.

Additional aspects related to the invention will be set forth in part in the description which follows, and in part will be obvious from the description, or may be learned by practice of the invention. Aspects of the invention may be realized and attained by means of the elements and combinations of various elements and aspects particularly pointed out in the following detailed description and the appended claims.

It is to be understood that both the foregoing and the following descriptions are exemplary and explanatory only and are not intended to limit the claimed invention or application thereof in any manner whatsoever.

### BRIEF DESCRIPTION OF THE DRAWINGS

The accompanying drawings, which are incorporated in and constitute a part of this specification exemplify the embodiments of the present invention and, together with the description, serve to explain and illustrate principles of the inventive technique. Specifically:

FIG. 1 illustrates a welcome screen of an imaging device showing targeted advertisements based on device history, according to aspects of the present invention.

FIG. 2 illustrates the welcome screen of the imaging device of FIG. 1 after the device history has changed, according to aspects of the present invention.

FIG. 3 illustrates a welcome screen of an imaging device showing targeted advertisements based on user history, according to aspects of the present invention.

FIG. 4 illustrates targeted advertisements on the screen of an imaging device receiving and queuing the documents transmitted by a user, according to aspects of the present invention.

FIG. 5 illustrates a printout of a web page with targeted advertisements added by the imaging device, according to aspects of the present invention.

FIG. 6A illustrates an imaging system incorporating one or more of the aspects shown in FIG. 1, FIG. 2, FIG. 3, FIG. 4 and FIG. 5, according to aspects of the present invention.

FIG. 6B illustrates the imaging system of FIG. 6A in communication with other systems and devices, according to aspects of the present invention.

FIG. 6C illustrates a block diagram of an exemplary multifunction device, according to aspects of the present invention.

FIG. 7 shows a flow chart of a method of delivering targeted advertisements through a document imaging system, according to aspects of the present invention.

FIG. 8 shows a flow chart of a method of targeting advertisements based on device history, according to aspects of the present invention.

FIG. 9 shows a flow chart of a method of targeting advertisements based on user history, according to aspects of the present invention.

FIG. 10 shows a flow chart of a method of determining targeted advertisements responsive to user demographic data, according to aspects of the present invention.

FIG. 11 shows a flow chart of a method of accounting for targeted advertisements, according to aspects of the present invention.

FIG. 12 illustrates an exemplary embodiment of a computer platform upon which the inventive system may be implemented.

### DETAILED DESCRIPTION

In the following detailed description, reference will be made to the accompanying drawings, in which identical functional elements are designated with like numerals. The aforementioned accompanying drawings show by way of illustration and not by way of limitation, specific embodiments and implementations consistent with principles of the present invention. These implementations are described in sufficient detail to enable those skilled in the art to practice the invention and it is to be understood that other implementations may be utilized and that structural changes and/or substitutions of various elements may be made without departing from the scope and spirit of present invention. The following detailed description is, therefore, not to be construed in a limited sense. Additionally, the various embodiments of the invention as described may be implemented in the form of a software running on a general purpose computer, in the form of a specialized hardware, or combination of software and hardware.

Aspects of the present invention, analyze contents of the documents processed by a MFD over a certain period of time to develop a device history. Aspects of the present invention, may also analyze contents of the documents processed at a MFD by a certain user during a certain period of time to develop a user history. Device history or user history are subsequently used to target advertisements to a user. The targeted advertisements are printed on the copied, scanned, faxed or printed page produced by MFD. The targeted advertisements may be displayed on the MFD display.

Aspects of the present invention, determine demographics of a user of a MFD to be able to target advertisements at the user. Demographics of the user can be inferred from the contents of at least one document provided to at least one MFD by the user. The targeted advertisements are printed on the copied, scanned, faxed or printed page produced by MFD.

Content analysis pertains to raster image representations of the document or documents and to page description language (PDL) representations of the document that is being printed by the MFD. The genre of a document pertains to the overall layout and content of a document and generally describes whether the document is an article, a photo, a table, a page of text, a web page and the like. PDL is the language used for input of print data to a printer.

While conventional web searches on many web sites yield targeted advertisements based on the context of the search, the advertisements appearing as a result of these conventional methods depend on the content being searched or viewed. On the other hand, the aspects of the present invention retrieve advertisements as part of the process of copying, scanning, faxing and printing physical documents. Therefore, retrieving the advertisements is not done when users view electronic documents. Further, with conventional methods, the advertisements that are retrieved when viewing a website are based on the context of the website. On the contrary, aspects of the present invention place advertisements that are independent of any marketing deals struck by content owners of the websites that are visited.

In conventional systems, advertisements may be placed via POS systems. For example, coupons may be printed with a grocery store receipt. However, in these conventional systems, transactional data collected during the sale is being used as opposed to image data and the advertisement targeting is not based on content analysis of any documents.

In conventional systems that provide targeted advertisements via self-service kiosks, such as a photo kiosk and greeting card kiosks, advertisement targeting is not based on document content analysis.

In conventional imaging systems, such as copiers, scanners, fax machines, and printers that provide a current document being imaged with advertisements, ad targeting is not based on document content analysis. In the one conventional system mentioned in the background section, keywords from the content of the document being copied are used to arrive at advertisements placed on the produced copy. This conventional system, however, uses the keywords of a single document; it does not disclose and is not geared for utilizing device history or user history; and it does not use demographics data. Further, this piece of prior art is only directed to text data and does not analyze graphics data or objects within a graphic and does not determine the genre of a document.

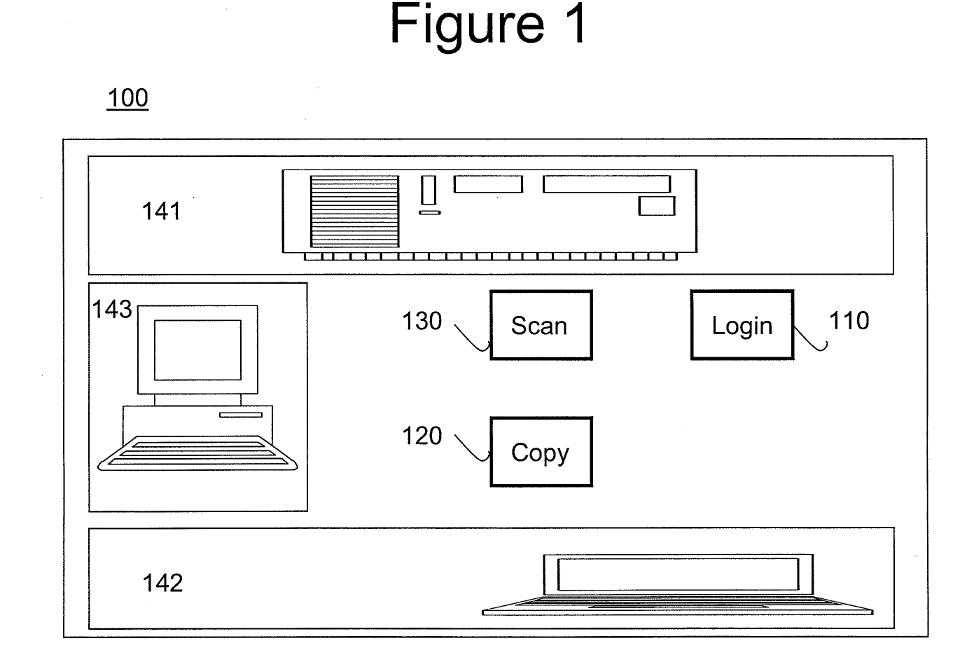

FIG. 1 illustrates a welcome screen of an imaging device showing targeted advertisements based on device history, according to aspects of the present invention.

FIG. 1 shows a welcome screen 100 of an imaging device or MFD. The particular device, shown in FIG. 1, has been used to process documents containing “high tech” related content. The context of these documents is determined to be a “high tech” context. As a result, the device history indicates “high tech” related history and the welcome screen is displaying “high tech” related advertisements.

The welcome screen 100 is shown to include a login button 110, a copy button 120 and a scan button 130. The buttons may be hard keys or soft keys appearing on the screen. The advertisements 141, 142, 143 shown on the welcome screen 100 all pertain to high-tech related items because the device has been more frequently used for copying or otherwise processing documents that were identified by the device as containing high-tech related content.

The content of each document may be in the form of images in the case the device was used for copying, scanning or faxing or PDL when the device was used for printing. The imaging device may be a copier, a fax machine, a scanner, a printer, another imaging device or an MFD including several functions.

For determining the frequently occurring topic within a collection of documents, an algorithm may be selected that first identifies the subject of a single document based on the content of the document and then determines the frequency of all documents having a certain identified subject. This type of algorithm, therefore, takes into account both the frequency of an identified term or picture within each document and the frequency of the documents including the identified terms and pictures.

The welcome screen uses a device based approach in targeting the advertisements because at this stage, a current document has not been presented to the device for copying and a particular user has not been identified by the device.

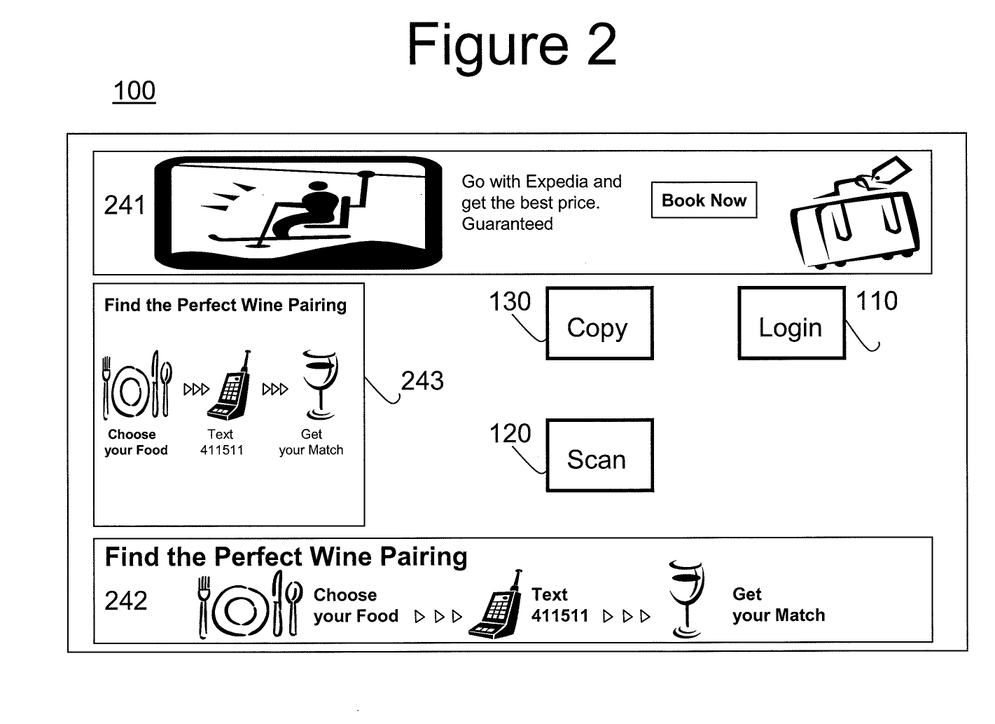

FIG. 2 illustrates the welcome screen of the imaging device of FIG. 1 after the device history has changed, according to aspects of the present invention.

FIG. 2 shows a welcome screen 100 of the same imaging device shown in FIG. 1. The particular device, shown in FIG. 2, has been more frequently used to process documents containing “luxury item” related content. The context of the documents processed at the device is determined to be a “luxury item” related context. As a result, the welcome screen is displaying “luxury item” related advertisements.

The welcome screen 100 is shown as including different advertisements 241, 242, 243. The advertisements 241, 242, 243 all pertain to luxury items because the device has been more frequently used for copying or otherwise processing documents that were identified by the device as containing content related to luxury items.

This device may be the same device shown in FIG. 1 after it has been used to copy more documents with “luxury item” related content than documents with “high tech” related content. The device may be a different device having its own luxury related content history.

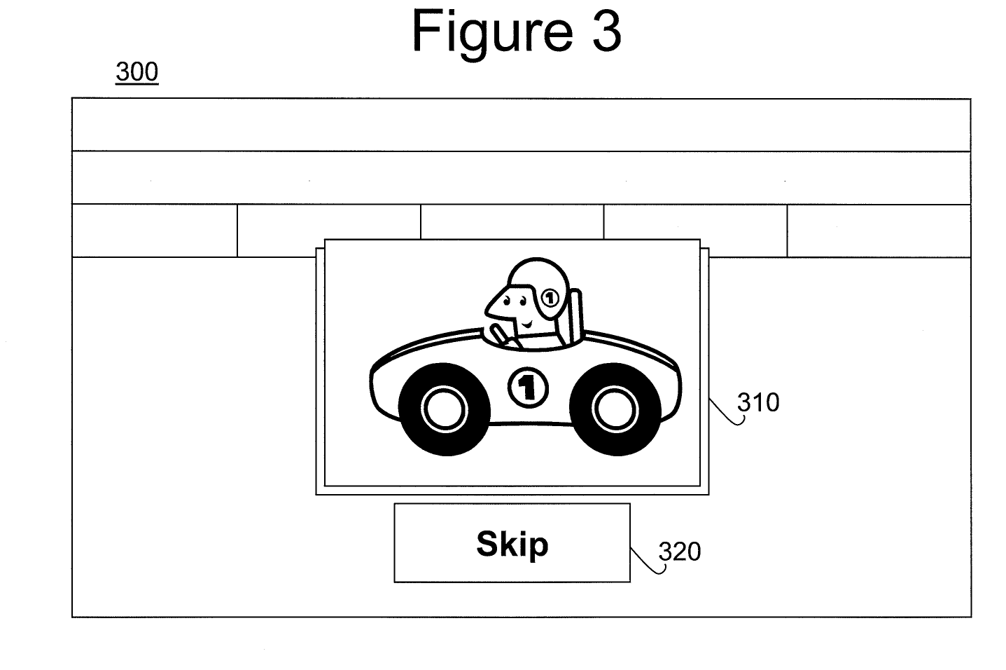

FIG. 3 illustrates a welcome screen of an imaging device showing targeted advertisements based on user history, according to aspects of the present invention.

FIG. 3 shows a screen 300 of the same imaging device of FIG. 1 and FIG. 2 or another similar device after the user has used the device for copying, scanning or otherwise processing a document. In FIG. 3, the device has received the document and has had the opportunity to identify the user and has determined the user to be targeted by a particular sports car manufacturer. The device has, therefore, retrieved a sport car video advertisement and is offering to show it to the user before providing the user with the copy of the user's document.

The device may identify the user based on a user identification input to the device directly or through a smart card.

One revenue model is shown in the exemplary FIG. 3. These drawings show a device display 300. The start screen of an advertisement video 310 and a skip button 320 are provided on the device display 300. The user is given a choice to watch the advertisement 310 and obtain a copy of his document for a discounted price, or skip the advertisement and pay full price for the copy he had requested. The user may skip the advertisement 310 by touching the skip button 310.

In the above example, the device has had the opportunity to identify the user. As such, at this stage, the advertisement may be targeted according to device history, as before, or according to user history. User history is based on document content of the documents processed by the user over a period of time. User history may be based on the contents of the documents that have been processed by the user at one single device or at a number of devices that are capable of communicating. The analyzed content of the current document that is being processed is added to the existing user history. User history may be saved on a smart card used by the user to activate the MFD. User history may be available at a central location communicating with several MFDs and may be made available to all of the MFDs communicating with the central location.

In the above example, user history is directly used to target advertisements at the user. In one aspect of the invention, the user history is used to first determine the demographics of the user and then the device determines user demographics to be a match for a demographic that is being targeted by the sports car manufacturer.

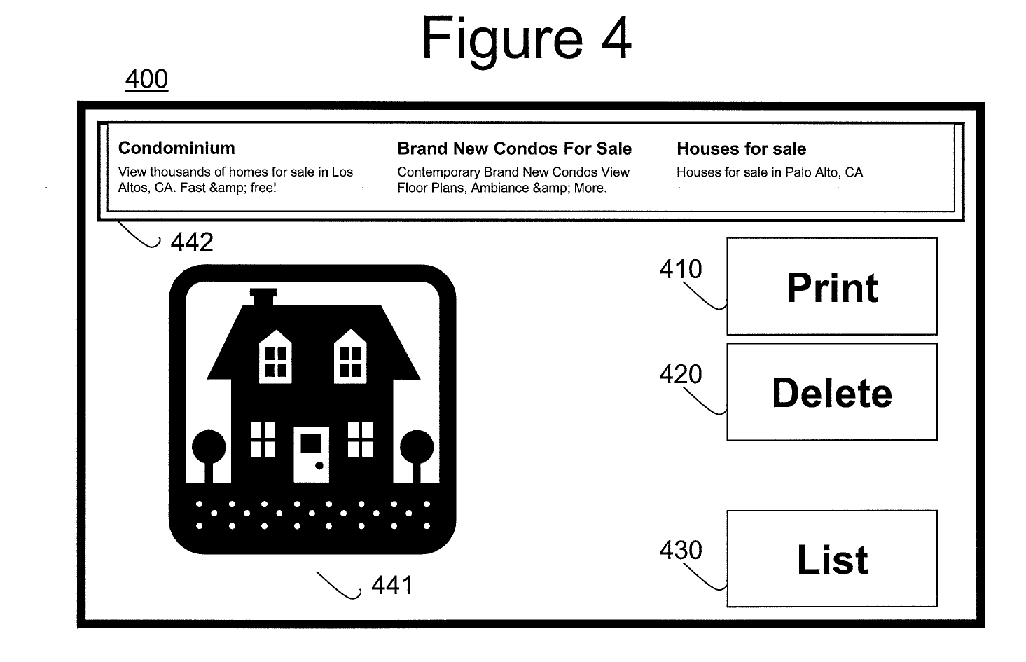

FIG. 4 illustrates targeted advertisements on the screen of an imaging device receiving and queuing the documents transmitted by a user, according to aspects of the present invention.

FIG. 4 shows a screen 400 of an imaging device. The screen 400 provides three options of print 410, delete 420 and list 430. A document 441 has been processed by this device. The document 441 may be transmitted by the user to the device for further processing. A queue of transmitted documents may exist at the device. The print button 410 permits the user to print the document being shown on the screen 400. The delete button 420 permits the user to delete the shown document from the queue. The list button 430 permits the user to list all of the documents in the queue.

In exemplary drawings shown, the device has retrieved three targeted text advertisements 442, which are displayed along the top of the screen 400. The advertisements may be targeted according to device history or according to user history. Alternatively, the demographics of the user may be inferred from the contents of the document, or otherwise discerned, and the advertisements may be targeted based on user demographics.

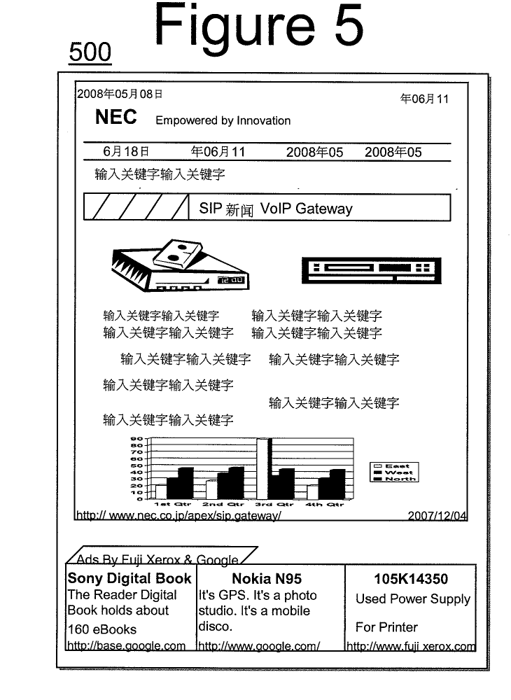

FIG. 5 show a printout of a web page with targeted advertisements added by the imaging device, according to aspects of the present invention.

FIG. 5 shows a printout 500 of a web page generated by a MFD or other imaging device according to aspects of the invention. These drawings show the printout 500 of a web page with targeted advertisements 510, 520, 530 added by the device. The addition of the advertisements 510, 520, 530 occurs by a device such as a printer and during the printing of the web page. These advertisements are not shown on the screen of the computer when the web page is being viewed on the screen.

The device retrieves targeted text advertisements from the device or from the web. These targeted advertisements are placed on the margin of the printout 500 of the web page as provided to the user. The targeted advertisements may be placed on the back of the printed page, in any white space detected on the printed page or in any other appropriate location on the printed page.

Web searches on many web sites yield targeted advertisements based on the context of the search string. Also, many web sites include targeted advertisements based on the content of the website. When a printout of these websites is obtained, targeted advertisements that appear on the web or in PDF documents, and have been shown to the user on the display, will also be included on the printout.

The aspects of the present invention, however, retrieve advertisements as part of the process of printing the document that has been retrieved. Retrieving the advertisements, in the aspects of the present invention, is not done when users view electronic documents and the advertisements do not appear on the display. Further, aspects of the present invention place advertisements that are independent of any marketing deals struck by content owners of the websites that are visited.

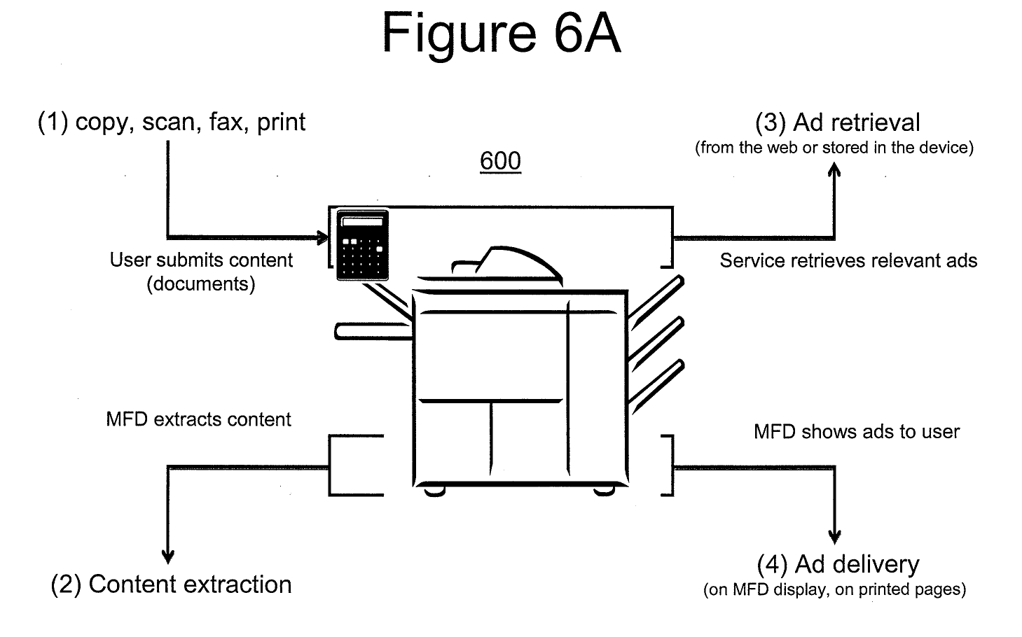

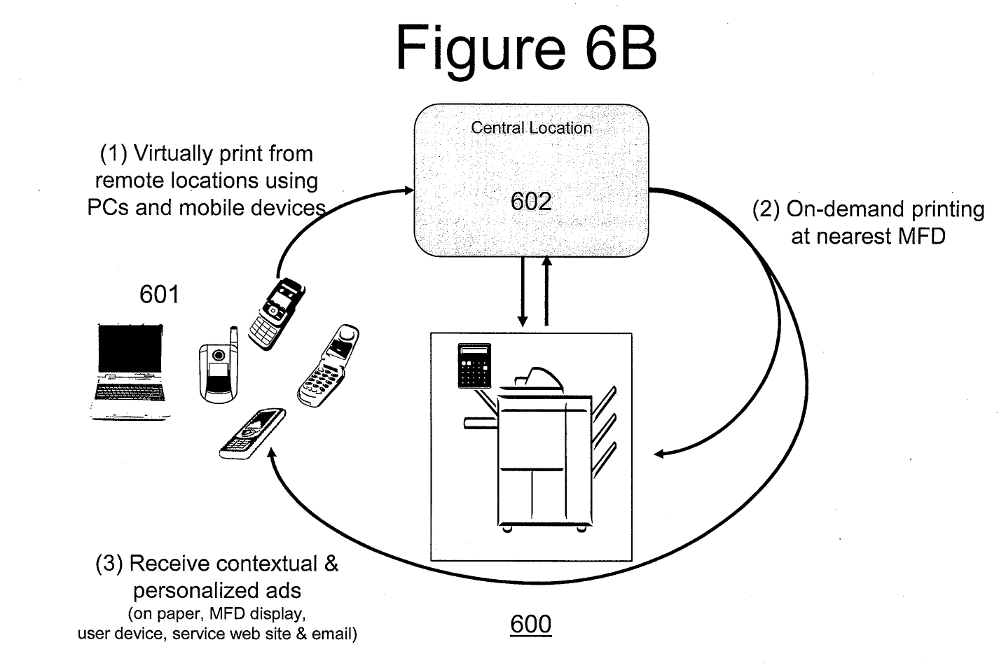

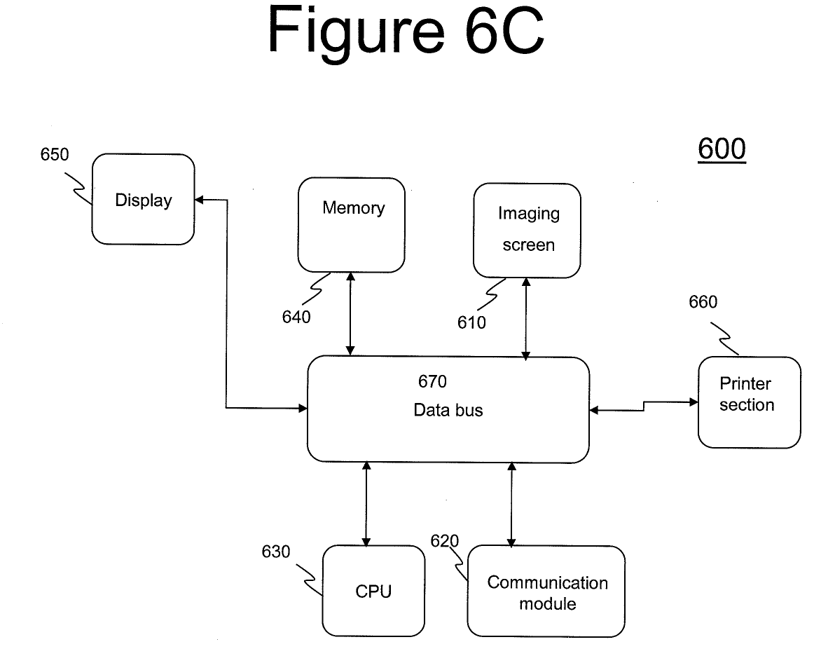

FIG. 6A shows an imaging system or device incorporating one or more of the aspects shown in FIG. 1, FIG. 2, FIG. 3, FIG. 4 and FIG. 5, according to aspects of the present invention.

FIG. 6A shows a MFD system or device 600. The device 600 may also be a copier, a scanner, a fax machine, a printer or another type of facsimile or document scanning or reproduction system. The device 600 includes one or more of the capabilities and attributes shown in the previous drawings.

At stage 1 in FIG. 6A, a user submits a document to the device 600. The document may include text documents, photographs or tables as content. The document is submitted directly at the device 600 or transmitted to it from a remote location. At stage 2, the device extracts the content from the document by optical character recognition or other methods of identifying images and objects within the images. The extracted content is incorporated into the device history and user history and may be used to infer the demographics of the user. Alternatively the device or user history may be used to infer the demographics of the user. At stage 3, the device 600 retrieves advertisements from the advertising networks or from a memory of the device itself. The retrieved advertisements are targeted according to device history, user history or user demographics. At stage 4, the device shows the targeted advertisement to the user on a device display or prints the advertisements on printed pages.

FIG. 6B shows the imaging system of FIG. 6A in communication with other systems and devices, according to aspects of the present invention.

FIG. 6B illustrates the concept of networking and communication between one particular MFD or other type of imaging device with other similar and dissimilar devices. The MFD 600 of FIG. 6B is in communication with personal computers and mobile devices 601 that may be remotely located. The MFD 600 is also in communication with a central location 602.

At stage 1, a user can request a service, for example send a print command, from his stationary or mobile device. At stage 2, the user request, for example the print command, is carried out at the nearest MFD or at an MFD requested by the user or determined by the central location 602. The printed copy may include targeted advertisement. At stage 3 targeted advertisements are received at the user's device.

FIG. 6C shows a block diagram of an exemplary multifunction device, according to aspects of the present invention.

The multifunction device 600 includes an imaging screen 610, a communication module 620, a processor 630, a memory 640, a display 650, and a printer section 660. The components are coupled together and capable of communicating with one another via a data bus 670. The imaging screen 610 is for imaging documents received at the device. The communication module 620 is for receiving documents transmitted to the device from remote locations and for transmitting data to remote locations. The processor 630 is for receiving an image of the documents and analyzing the image to obtain document contents of the documents. The memory 640 is for storing the document contents. The display 650 is for displaying targeted advertisements to users of the device. The printer section 660 is for printing modified documents, the modified documents including the documents received at the device and the targeted advertisements provided at the device.

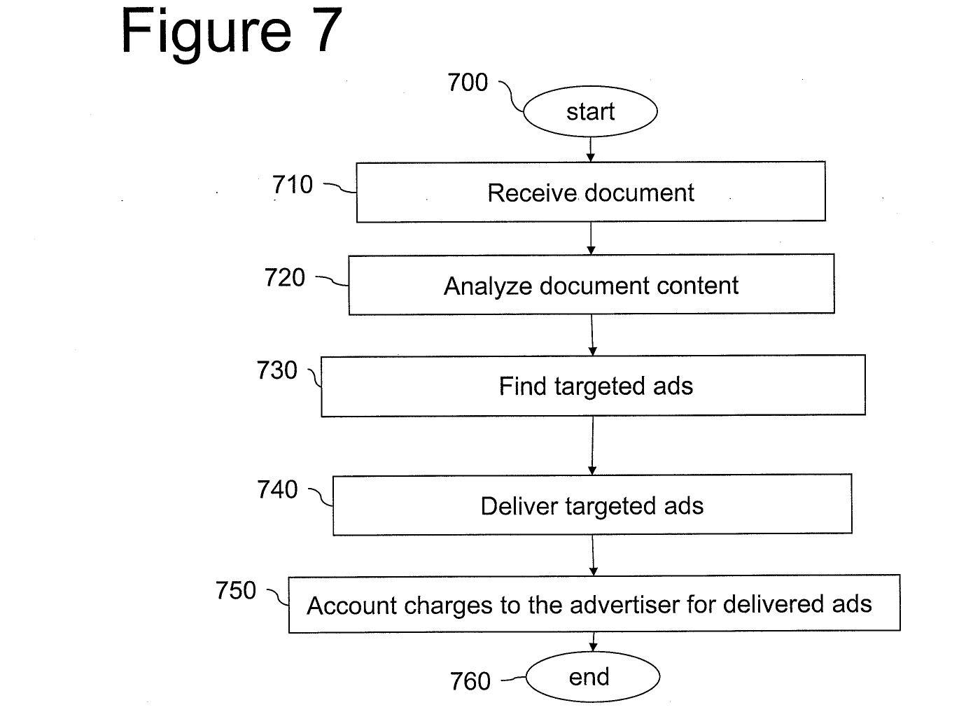

FIG. 7 shows a flow chart of a method of delivering targeted advertisements through a document imaging system, according to aspects of the present invention.

FIG. 7 shows an exemplary method for delivering targeted advertisements to users of document imaging systems. The method begins at 700. At 710, the document that is being processed at the imaging system is received and input to the imaging system. At 720, a document analysis is performed by the imaging system. At 730, the imaging system determines targeted advertisements. At 740, the targeted advertisements are delivered to the user of the imaging system. At 750, an accounting of the amount to be charged to the advertiser is made by the system. At 760, the method ends.

At 710, document input to the system may be achieved in a variety of ways. In one aspect, the user can input document data to the system by capturing an image of a document using copy, scan, or fax functions. In another aspect, the user can input document data to the system by submitting print data using a device-compatible PDL, including text, pixel, and vector information.

At 720, the document is analyzed to extract context. During document analysis, the device extracts text, graphical or photographic elements and layout of the document. The context of the document is determined as a result of document analysis.

The system extracts any available text, pixel, and vector information from the scanned image data or submitted print data. Extraction of text may be performed by OCR.

The system identifies keywords and objects by analyzing the extracted text and images to compute higher-level document characteristics, for example, significant keywords detected in the text and significant objects detected in the pictures and graphics.

The system may also analyze the document data and/or computed characteristics to classify the document and, for example, identify document genre. Useful non-textual attributes of the document include the presence and proportion of photographs, graphics, text, or tables, and the layout style of the document. The layout style includes font size, presence or absence of title and number of text columns.

The above features and attributes of scanned data of the document can be combined heuristically or systematically, for example, by using machine learning methods, to determine the “genre” of the document. Genres may be categories such as magazine article, newspaper article, letter, spreadsheet, map, and photograph. The automatically determined document genre can be used as one of the parameters for advertisement selection. The document features may also be incorporated into demographic mapping methods described below without an explicit classification of genre.

Aspects of the invention can perform document analysis and apply results in real-time to select advertisements for documents while they are being copied, printed, scanned, faxed or otherwise processed. Aspects of the invention can also store analysis results and aggregate them over time to create device history and user history.

At 730, the targeting is based on device history, user history or user demographics inferred from the content of the document that has been determined at the analysis stage 720.

At 740, the targeted advertisements may be delivered in a variety of formats and using a variety of delivery means. The formats include text advertisements, image advertisements, audio advertisements, video advertisements, and interactive advertisements. The delivery means used for delivering the targeted advertisements include delivery on printed paper, on the device display, on a large collocated display, on the user's printable card, on the user's portable storage/processing device, in a modified electronic version of a scanned document, or via an electronic “job receipt” or email sent to the user. The delivery format and delivery means or medium may be selected by the device or by the user.

At 760, the accounting may be according to a CPM method if the advertisements are shown on the display or printed. The accounting may be according to a CPC method if the advertisements are shown on the display and the user is given the opportunity to follow up with the advertisement by clicking on it.

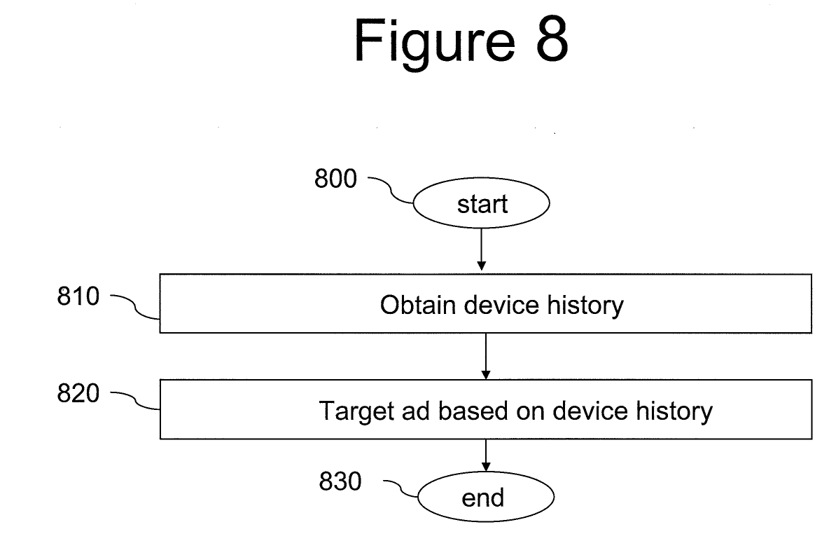

FIG. 8 shows a flow chart of a method of targeting advertisements based on device history, according to aspects of the present invention.

The method of FIG. 8 begins at 800. At 810, device history is retrieved. At 820, advertisement targeting is performed based on device history. At 830, the process of targeting advertisement based on device history ends.

At 810, the device history is retrieved from the history that is stored at the device or at a central location communicating with the device. The device history is accumulated over certain and predetermined or flexible periods of time. The device history is determined based on the results of the content analysis performed on the contents of the documents that are processed by the device.

Analyzing the contents of a document yield several type of information. These types of information are organized and stored for each device as device history.

At 820, the targeting based on the device history, may be based on particular keywords and objects found in the documents that are frequently processed by the device.

In one aspect, the device history may be correlated to demographics of the use at the particular device. In this situation, advertisements may be targeted to the demographics of the users who frequently use the particular device. The demographics are determined from analyzing the documents that are processed at the device over a period of time.

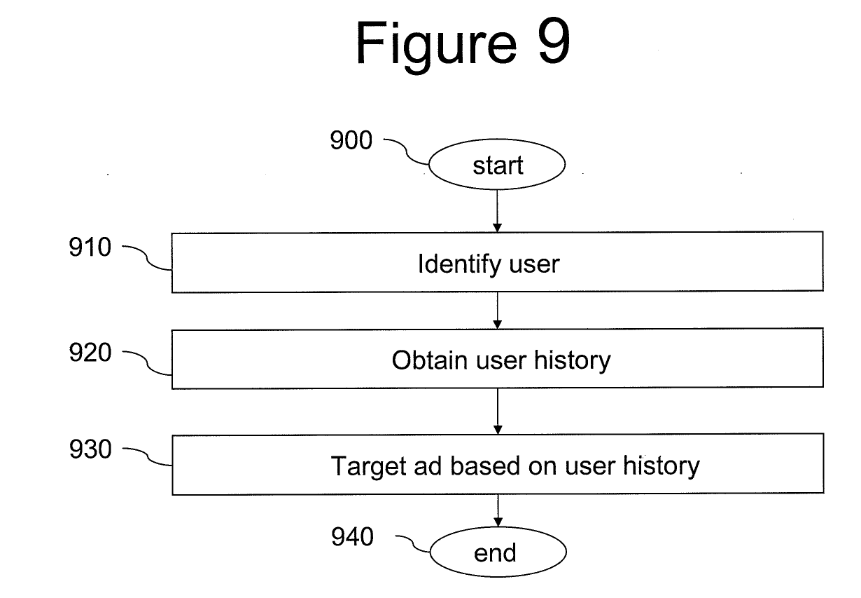

FIG. 9 shows a flow chart of a method of targeting advertisements based on user history, according to aspects of the present invention.

The method of targeting advertisements based on user history begins at 900. At 910, the user is identified. At 920, the device obtains user history. At 930, the advertisements are targeted based on user history. At 940, the process of targeting advertisements ends.

User history pertains to the history of documents that are processed by the user. User history may be based on particular keywords or objects contained in documents that are frequently submitted by a user. The user history may pertain to the documents processed at one device over a period of time. The user history may alternatively pertain to the documents that are processed by the same user at a number of devices when the use data from all of the devices is available to the device being currently used. The user history may be available on a smart card used by the user at the device.

At 910, the user is identified either by direct input to the device by the user, through a smart card used by the user or as a result of analyzing a current document being processed by the user.

At 920, the device may obtain user history from the history stored on the device or from a central location that accumulates user data from several devices.

At 930, advertisements may be directed according to different aspects of user history. Analyzing the contents of the documents processed by the user yields several categories of indicators. The categories of indicators include keywords, objects in the graphics, genre of the document, and the like. Some of these categories of indicators may be used for targeting advertisements.

Alternatively at 930, user demographics may be inferred from user history of document processing. Then the user demographics are used for targeting advertisements.

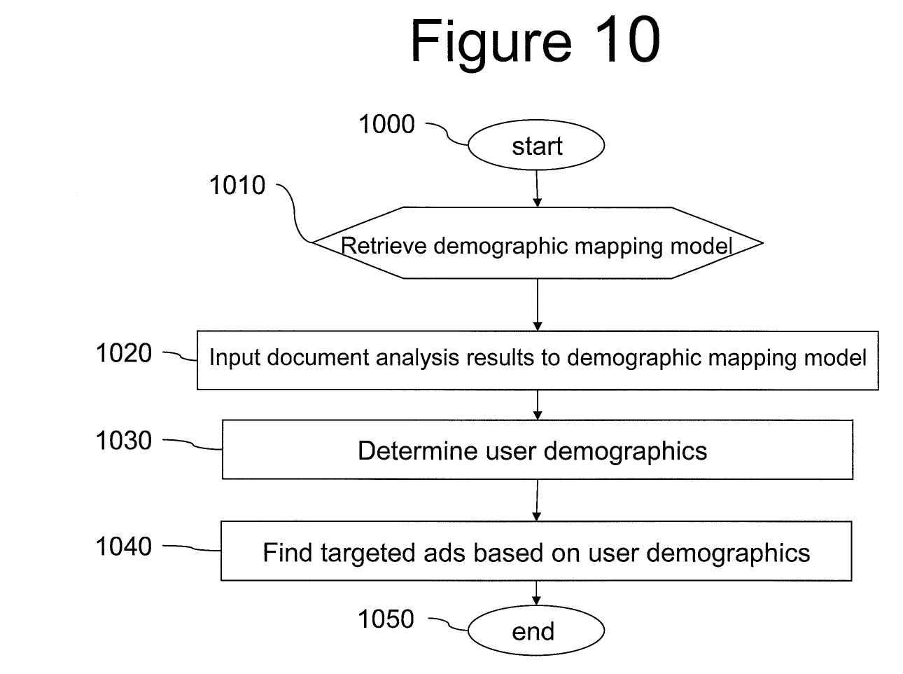

FIG. 10 shows a flow chart of a method of determining targeted advertisements responsive to user demographic data, according to aspects of the present invention.

In one aspect of the invention, targeted advertisements are found based on user demographic data. The system uses a demographic model that provides a mapping between the document analysis results and user demographic data. User demographic data include the user's age, gender, and the like. User demographic data may also include information about specific user areas of interest, such as ‘soccer’ or ‘movies’, that may be exploited by advertisers irrespective of his age, gender and the like.

The method shown in FIG. 10 begins at 1000. At 1010, the device selects a demographic mapping model to be used. At 1020, the data resulting from document analysis are input into the selected demographics model. At 1030, the demographics of the user are output by the model responsive to input of the current document contents. At 1040, targeted advertisements are selected based on the user's demographics determined from the model. At 1050, the process of selecting targeted advertisements based on user demographics ends.

At 1010, the mapping model selected may be a theoretical model. Alternatively, the mapping model may be an empirical model. Empirical models may be generated by collecting user demographic data and correlating this data with a population of documents that the user has submitted to one or more document imaging devices at one time or over a certain period of time.

Given a body of documents submitted by a user with known associated user demographics, obtaining an empirical model can be framed as an automatic annotation or tagging problem. Solutions to automatic annotation or tagging problems have been investigated using a variety of machine learning methods, for example, support vector machine (SVM), nearest-neighbor and Gaussian mixture model (GMM).

For automatic annotation or tagging, each demographic category can be treated as a label for which there is a set of positive and negative examples available as training data. Documents from within the demographic set would be the positive examples and documents outside the demographic set would be the negative examples. This is a single-label learning task that is well suited to SVMs, decision trees and the like. When the expected number of labels, i.e. demographic categories, is small, it is feasible to train individual classifiers for each demographic category. The result of automatic classification may be a discrete decision between mutually exclusive labels, or a score for every available label.

For the case of an aggregated set of documents which incorporates documents drawn from many demographics, the outputs of the single-document classifiers described above may be accumulated over the individual documents to arrive at a distribution of demographics for the collection. Alternatively, well-known distribution modeling methods may be used. A model, such as a GMM, may be estimated based on the training data for each demographic category. Given a set of unlabeled test documents, the likelihood that the set was produced by each of the single-demographic GMMs can be measured. The resulting likelihoods are used to estimate the demographic distribution of the test documents. This is just one outline of how document content might be mapped to demographic data. A variety of well-studied statistical analysis techniques are available to be applied to this problem.

The advertisement selection algorithm may also combine various other features in addition to demographics inferred from document content to improve advertisement targeting. These other features include (a) user image and voice capture and (b) location of the device. Both factors may be used to further refine the inferred demographics. Location of the device may be in a convenience store, library, university, white-collar office, or blue-collar work site. Nearby businesses/institutions may also be relevant for determining or refining user demographics. For example, the device may be near a university, near an upscale shopping district or near an electronics district like. The time of day may be relevant for determining the type of advertisement. For example, advertisements may vary during the morning coffee hours from advertisements for the late night student and partygoers. Owner/leaser preferences also determine the advertisements. For example, coupons for use in this store, automatic filtering of competitors' advertisements and advertiser bid prices and budgets may be used to determine the advertisement delivered to the user.

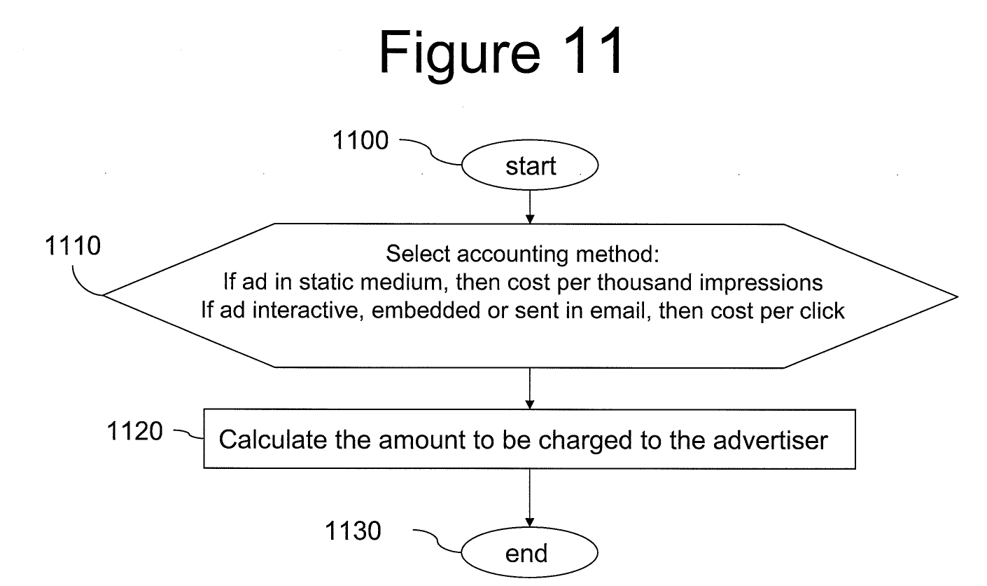

FIG. 11 shows a flow chart of a method of accounting for targeted advertisements, according to aspects of the present invention.

The device has to keep track of the advertisements shown to the user in order to charge the advertisers. In FIG. 11, the method of accounting for the targeted advertisements begins at 1100. At 1110, the method of accounting is selected based on the type of ad. At 1120, the charge for the ad is determined. At 1130, the accounting process ends.

Multiple advertising accounting models are supported by aspects of the present invention. Examples of the accounting models include cost-per-thousand-impressions (CPM) and cost-per-click (CPC). Advertisements on a static medium like paper and non-interactive display advertisements can be accounted with the CPM model. On the other hand, interactive advertisements on the device's screen, embedded in an electronic version of a scan, and sent in email receipts can be accounted with the CPC model. CPC provides more value for the advertisers and consequently generates more revenue for the advertising network.

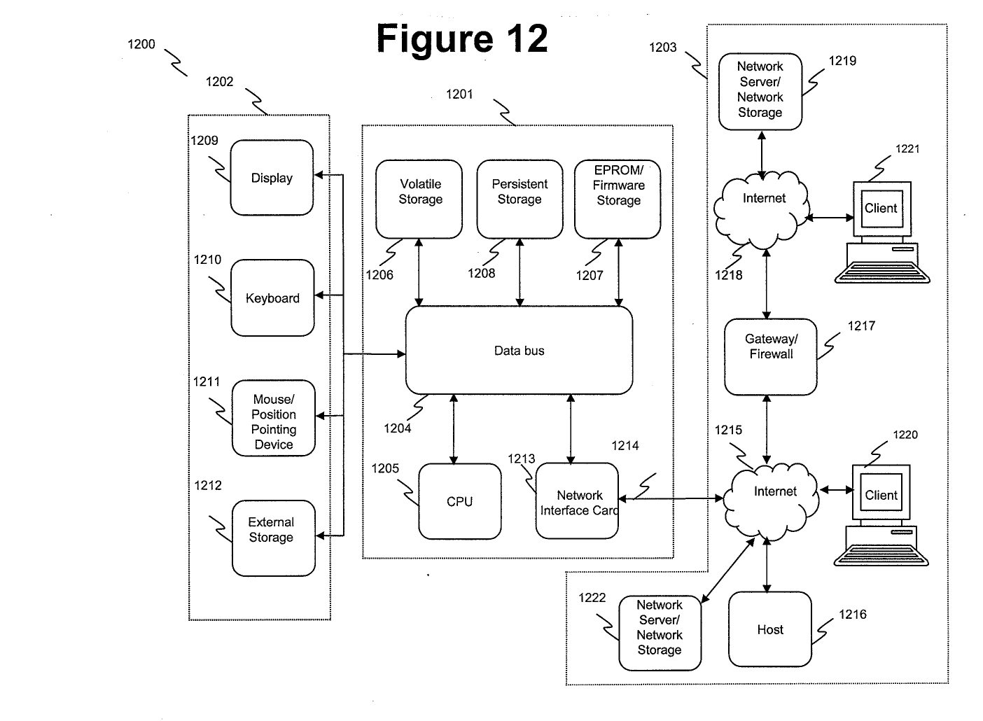

FIG. 12 is a block diagram that illustrates an embodiment of a computer/server system 1200 upon which an embodiment of the inventive methodology may be implemented. The system 1200 includes a computer/server platform 1201, peripheral devices 1202 and network resources 1203.

The computer platform 1201 may include a data bus 1204 or other communication mechanism for communicating information across and among various parts of the computer platform 1201, and a processor 1205 coupled with bus 1201 for processing information and performing other computational and control tasks. Computer platform 1201 also includes a volatile storage 1206, such as a random access memory (RAM) or other dynamic storage device, coupled to bus 1204 for storing various information as well as instructions to be executed by processor 1205. The volatile storage 1206 also may be used for storing temporary variables or other intermediate information during execution of instructions by processor 1205. Computer platform 1201 may further include a read only memory (ROM or EPROM) 1207 or other static storage device coupled to bus 1204 for storing static information and instructions for processor 1205, such as basic input-output system (BIOS), as well as various system configuration parameters. A persistent storage device 1208, such as a magnetic disk, optical disk, or solid-state flash memory device is provided and coupled to bus 1201 for storing information and instructions.

Computer platform 1201 may be coupled via bus 1204 to a display 1209, such as a cathode ray tube (CRT), plasma display, or a liquid crystal display (LCD), for displaying information to a system administrator or user of the computer platform 1201. An input device 1210, including alphanumeric and other keys, is coupled to bus 1201 for communicating information and command selections to processor 1205. Another type of user input device is cursor control device 1211, such as a mouse, a trackball, or cursor direction keys for communicating direction information and command selections to processor 1204 and for controlling cursor movement on display 1209. This input device typically has two degrees of freedom in two axes, a first axis (e.g., x) and a second axis (e.g., y), that allows the device to specify positions in a plane.

An external storage device 1212 may be connected to the computer platform 1201 via bus 1204 to provide an extra or removable storage capacity for the computer platform 1201. In an embodiment of the computer system 1200, the external removable storage device 1212 may be used to facilitate exchange of data with other computer systems.

The invention is related to the use of computer system 1200 for implementing the techniques described herein. In an embodiment, the inventive system may reside on a machine such as computer platform 1201. According to one embodiment of the invention, the techniques described herein are performed by computer system 1200 in response to processor 1205 executing one or more sequences of one or more instructions contained in the volatile memory 1206. Such instructions may be read into volatile memory 1206 from another computer-readable medium, such as persistent storage device 1208. Execution of the sequences of instructions contained in the volatile memory 1206 causes processor 1205 to perform the process steps described herein. In alternative embodiments, hard-wired circuitry may be used in place of or in combination with software instructions to implement the invention. Thus, embodiments of the invention are not limited to any specific combination of hardware circuitry and software.

The term “computer-readable medium” as used herein refers to any medium that participates in providing instructions to processor 1205 for execution. The computer-readable medium is just one example of a machine-readable medium, which may carry instructions for implementing any of the methods and/or techniques described herein. Such a medium may take many forms, including but not limited to, non-volatile media, volatile media, and transmission media. Non-volatile media includes, for example, optical or magnetic disks, such as storage device 1208. Volatile media includes dynamic memory, such as volatile storage 1206. Transmission media includes coaxial cables, copper wire and fiber optics, including the wires that comprise data bus 1204.

Common forms of computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, an EPROM, a FLASH-EPROM, a flash drive, a memory card, any other memory chip or cartridge, or any other physical medium from which a computer can read.

Various forms of computer readable media may be involved in carrying one or more sequences of one or more instructions to processor 705 for execution. For example, the instructions may initially be carried on a magnetic disk from a remote computer. Alternatively, a remote computer can load the instructions into its dynamic memory and send the instructions over a telephone line using a modem. A modem local to computer system 1200 can receive the data on the telephone line and use an infra-red transmitter to convert the data to an infra-red signal. An infra-red detector can receive the data carried in the infra-red signal and appropriate circuitry can place the data on the data bus 1204. The bus 1204 carries the data to the volatile storage 1206, from which processor 1205 retrieves and executes the instructions. The instructions received by the volatile memory 1206 may optionally be stored on persistent storage device 1208 either before or after execution by processor 1205. The instructions may also be downloaded into the computer platform 1201 via Internet using a variety of network data communication protocols well known in the art.

The computer platform 1201 also includes a communication interface, such as network interface card 1213 coupled to the data bus 1204. Communication interface 1213 provides-a two-way data communication coupling to a network link 1214 that is connected to a local network 1215. For example, communication interface 1213 may be an integrated services digital network (ISDN) card or a modem to provide a data communication connection to a corresponding type of telephone line. As another example, communication interface 1213 may be a local area network interface card (LAN NIC) to provide a data communication connection to a compatible LAN. Wireless links, such as well-known 802.11a, 802.11b, 802.11g and Bluetooth may also used for network implementation. In any such implementation, communication interface 1213 sends and receives electrical, electromagnetic or optical signals that carry digital data streams representing various types of information.

Network link 1213 typically provides data communication through one or more networks to other network resources. For example, network link 1214 may provide a connection through local network 1215 to a host computer 1216, or a network storage/server 1217. Additionally or alternatively, the network link 1213 may connect through gateway/firewall 1217 to the wide-area or global network 1218, such as an Internet. Thus, the computer platform 1201 can access network resources located anywhere on the Internet 1218, such as a remote network storage/server 1219. On the other hand, the computer platform 1201 may also be accessed by clients located anywhere on the local area network 1215 and/or the Internet 1218. The network clients 1220 and 1221 may themselves be implemented based on the computer platform similar to the platform 1201.

Local network 1215 and the Internet 1218 both use electrical, electromagnetic or optical signals that carry digital data streams. The signals through the various networks and the signals on network link 1214 and through communication interface 1213, which carry the digital data to and from computer platform 1201, are exemplary forms of carrier waves transporting the information.

Computer platform 1201 can send messages and receive data, including program code, through the variety of network(s) including Internet 1218 and LAN 1215, network link 1214 and communication interface 1213. In the Internet example, when the system 1201 acts as a network server, it might transmit a requested code or data for an application program running on client(s) 1220 and/or 1221 through Internet 1218, gateway/firewall 1217, local area network 1215 and communication interface 1213. Similarly, it may receive code from other network resources.

The received code may be executed by processor 1205 as it is received, and/or stored in persistent or volatile storage devices 1208 and 1206, respectively, or other non-volatile storage for later execution. In this manner, computer system 1201 may obtain application code in the form of a carrier wave.

Finally, it should be understood that processes and techniques described herein are not inherently related to any particular apparatus and may be implemented by any suitable combination of components. Further, various types of general purpose devices may be used in accordance with the teachings described herein. It may also prove advantageous to construct specialized apparatus to perform the method steps described herein. The present invention has been described in relation to particular examples, which are intended in all respects to be illustrative rather than restrictive. Those skilled in the art will appreciate that many different combinations of hardware, software, and firmware will be suitable for practicing the present invention. For example, the described software may be implemented in a wide variety of programming or scripting languages, such as Assembler, C/C++, perl, shell, PHP, Java, etc.

Moreover, other implementations of the invention will be apparent to those skilled in the art from consideration of the specification and practice of the invention disclosed herein. Various aspects and/or components of the described embodiments may be used singly or in any combination in the inventive advertising system. It is intended that the specification and examples be considered as exemplary only, with a true scope and spirit of the invention being indicated by the following claims and their equivalents.

What is claimed is:

1. A method for delivering targeted advertisements to a user of a multifunction device, the method comprising:
identifying the user;
obtaining user history, the user history being a compilation of data determined from contents of documents processed by the user;
targeting advertisements to the user responsive to the user history to obtain user targeted advertisement; and
delivering the user targeted advertisement to the user.

2. The method of claim 1, further comprising:
receiving a current document from the user;
analyzing a content of the current document;
modifying the user history according to the content of the current document.

3. The method of claim 1, wherein the user history is compiled from the contents of the documents processed during a first period of time responsive to requests from the user.

4. The method of claim 1, wherein the user history is compiled from the contents of the documents processed at a plurality of multifunction devices adapted to sharing information responsive to requests from the user.

5. The method of claim 1, further comprising:
obtaining device history, the device history being a compilation of data determined from contents of documents processed by the multifunction device;
targeting advertisements responsive to the device history to obtain device targeted advertisement; and
displaying the device targeted advertisements on a display of the multifunction device.

6. The method of claim 1, further comprising:
accounting for charges to advertisers for the user targeted advertisement delivered.

7. The method of claim 1, further comprising:
receiving a current document from the user; and
analyzing a content of the current document;
wherein the analyzing includes analyzing an image of the current document for determining keywords and graphics if the current document is being processed responsive to a copy, scan or fax request, and
wherein the analyzing includes determining data from a page description language for the current document if the current document is being processed responsive to a print request.

8. The method of claim 1, further comprising:
determining user demographics of the user; and
refining the targeting responsive to the user demographics,

9. The method of claim 8, wherein the user demographics is determined from at least one document from the user history.

10. A method for delivering targeted advertisements to a multifunction device, the method comprising:
obtaining a device history, the device history being a compilation of data determined from contents of documents processed by the multifunction device during a first period;
targeting advertisements to the multifunction device responsive to the device history to obtain device targeted advertisement; and
delivering the advertisement to the user at the multifunction device.

11. The method of claim 10, further comprising:
accounting for charges to advertisers for the device targeted advertisement delivered to the multifunction device.

12. The method of claim 11, wherein the accounting is performed according to a cost per thousand impressions method of accounting.

13. The method of claim 10,
wherein the targeting is further responsive advertiser bid prices,
wherein multiple advertising types are supported by the multifunction device, and
wherein the device targeted advertisements are delivered via means selected from display of the multifunction device, a collocated display, print, printable card of a user, and email to the user.

14. A method for delivering targeted advertisements to a user of a multifunction device, the method comprising:
receiving a current document from a user;
analyzing content of the current document to obtain document analysis results;
retrieving a demographic mapping model;
determining user demographics for the user from input of the document analysis results to the demographic mapping model;
targeting advertisements to the user responsive to the user demographics to obtain user targeted advertisement; and
delivering the user targeted advertisement to the user.

15. The method of claim 14, further comprising:
compiling a user history from contents of documents processed according to user requests; and
refining the targeting according to the user history.

16. The method of claim 14, further comprising:
compiling a device history from contents of documents processed at the multifunction device; and
displaying device targeted advertisements on a display of the multifunction device.

17. The method of claim 14, further comprising:
receiving documents for processing at a plurality of multifunction devices including the multifunction device and from a plurality of users including the user;
analyzing the documents for content to obtain document analysis results; and
forming the demographic mapping model by determining a relationship between the users and corresponding document analysis results.

18. A multifunction device for providing targeted advertisements, the multifunction device comprising:
an imaging screen for imaging documents received at the device;
a communication module for receiving documents transmitted to the device from remote locations and for transmitting data to remote locations;
a processor for receiving an image of the documents from the imaging screen and for analyzing the image to obtain document contents of the documents;
a memory for storing the document contents;
a display for displaying targeted advertisements to users of the device; and
a printer for printing modified documents, the modified documents including the documents received at the device and the targeted advertisements provided at the device,
wherein targeted advertisements include first targeted advertisements,
wherein the first targeted advertisements are targeted to each of the users according to user history, and
wherein the user history is compiled from contents of the documents processed responsive to requests from the user.

19. The multifunction device of claim 18,
wherein targeted advertisements include second targeted advertisements,
wherein the second targeted advertisements are targeted to the device according to device history, and
wherein the device history is compiled from contents of the documents processed at the device.

20. The multifunction device of claim 18,
wherein targeted advertisements include second targeted advertisements,
wherein the second targeted advertisements are targeted to the users according to user demographics, and
wherein the user demographics is determined from input of content of a document provided to the device by the user into a demographic mapping model.
